(19) United States
(12) Patent Application Publication
(10) Pub. No.: US 2016/0320530 A1
(43) Pub. Date: Nov. 3, 2016

(54) OPTICAL MEMBER, METHOD FOR MANUFACTURING THE SAME, AND IMAGE PICKUP DEVICE

(71) Applicant: Panasonic Intellectual Property Management Co., Ltd., Osaka (JP)

(72) Inventors: MAKOTO UMETANI, Osaka (JP); IWAO UENO, Kyoto (JP)

(21) Appl. No.: 15/208,826

(22) Filed: Jul. 13, 2016

Related U.S. Application Data
(63) Continuation of application No. PCT/JP2015/004239, filed on Aug. 25, 2015.

(30) Foreign Application Priority Data
Sep. 25, 2014 (JP) 2014-195436
Mar. 6, 2015 (JP) 2015-045134

(51) Int. Cl. G02B 1/118; G02B 1/111; B01J 23/50

(52) U.S. Cl. CPC G02B 1/118; B01J 23/50; G02B 1/111

(57) ABSTRACT

Provided is an optical member that has a catalyst layer formed on its optical functional surface and zinc oxide formed to have a minute uneven structure where bump structures, each of which is oriented in a C-axis and is of a bell shape or a pyramid shape, are disposed substantially periodically on a surface of the catalyst layer. Preferably, the catalyst layer contains a catalyst material mainly including at least one element selected from among palladium, platinum, gold, silver, ruthenium, and rhodium. Thus, the optical member having a minute uneven structure formed on its surface and a method for easily manufacturing such an optical member can be provided.

### BACKGROUND

1. Technical Field

The technology disclosed here relates to an optical member having a minute uneven structure formed on its surface, a method for manufacturing the optical member, and an image pickup device using the optical member.

2. Description of Related Art

Conventionally, the optical member having the minute uneven structure formed on its surface has been known. Such an optical member has an effect of reducing reflection of light. Unexamined Japanese Patent Publication No. 2009-128540, Unexamined Japanese Patent Publication No. 2006-243633, and Unexamined Japanese Patent Publication No. 2006-235195 each disclose an optical member (antireflection structure) having a minute uneven structure formed on its surface in order to reduce reflection of light.

A disclosed technology of Unexamined Japanese Patent Publication No. 2009-128540 forms an uneven structure on a surface of a substrate by forming a resist layer on the surface of the substrate comprised of glass, metal, ceramic, resin, or the like, forming a mask by forming a pattern on the resist layer through lithography using an electron beam or a proton beam, and performing etching using the mask.

A disclosed technology of Unexamined Japanese Patent Publication No. 2006-243633 forms an uneven structure on a surface of a glass substrate by forming a resist layer on the surface of the glass substrate, forming a mask including a minute shape by performing hologram exposure with two-beam interference on the resist layer, and performing etching using the mask.

A disclosed technology of Unexamined Japanese Patent Publication No. 2006-235195 forms an uneven structure on a surface of an optical component by arranging an X-ray mask onto the optical component formed of a photosensitive material at a predetermined interval, and irradiating the optical component with X-ray through the X-ray mask.

### SUMMARY

Naturally enough, it is desired that the minute uneven structure can be formed easily on any optical members. However, by disclosed technologies of Unexamined Japanese Patent Publication No. 2009-128540, Unexamined Japanese Patent Publication No. 2006-243633, and Unexamined Japanese Patent Publication No. 2006-235195, minute uneven structures are formed on various optical members through complicated processes, and therefore, it is difficult to form the minute uneven structure on optical members such as an inner surface of a lens barrel and a display surface. This is because these members have a curved surface, an inner surface of the barrel, a large area, and the like and it is difficult to control an electron beam, interference light with light, and X-ray with high precision.

A technology disclosed here is made in view of the above circumstances, and provides an optical member having a minute uneven structure formed on its surface and a method for easily manufacturing such an optical member. According to the technology disclosed here, it is possible to form the minute uneven structure on optical members that each have an optical functional surface such as an inner surface of a lens barrel and a display surface; for example, optical members having shapes of a curved surface, an inner surface of a barrel, and a large area, which are conventionally difficult to form the minute uneven structures.

The technology disclosed here is an optical member that has a catalyst layer formed on an optical functional surface and zinc oxide formed to have the minute uneven structure where bump structures each of which is oriented in a C-axis and is of a bell shape or a pyramid shape are disposed substantially periodically on a surface of the catalyst layer. Preferably, the catalyst layer contains a catalyst material mainly including at least one element selected from among palladium, platinum, gold, silver, ruthenium, and rhodium.

In the technology disclosed here, the C-axis of the ZnO crystal means a crystallographic axis of ZnO that extends from a catalyst layer surface toward an air layer side. For example, the C-axis may extend in an inclined direction to an optical axis X, may extend so as to be curved to the optical axis X, or may extend to bend. Preferably, the C-axis of the ZnO crystal extends perpendicularly from the catalyst layer surface toward the air layer side.

Moreover, the technology disclosed here is a method for manufacturing an optical member that includes: a first step of putting an optical functional surface of the optical member into an aqueous solution that includes at least one element selected from among palladium, platinum, gold, silver, ruthenium, and rhodium to form a catalyst layer mainly including at least one element on the optical functional surface; a second step of generating zinc oxide of hexagonal pillar bump structures oriented in a C-axis on a surface of the catalyst layer by putting the optical functional surface of the optical member having the catalyst layer formed on its surface into an aqueous solution containing zinc oxide; and a third step of forming zinc oxide of the hexagonal pillar bump structures into bump structures of a bell shape or a conical shape by dry etching or wet etching.

Alternatively, the technology disclosed here is a method for manufacturing an optical member that has: a first step of putting the optical functional surface of the optical member into an aqueous solution that includes at least one element selected from among palladium, platinum, gold, silver, ruthenium, and rhodium and forming a catalyst layer mainly including at least one element on the optical functional surface; and a second step of generating zinc oxide of bump structures, each of which is oriented in a C-axis and is of a hexagonal pyramid shape or a bell shape, by putting the optical functional surface of the optical member having the catalyst layer formed on its surface into an aqueous solution containing zinc oxide.

According to this disclosed technology, it is possible to provide the optical member having the minute uneven structure formed on its surface and the method for manufacturing such an optical member.

### BRIEF DESCRIPTION OF DRAWINGS

FIG. 1 is a schematic diagram of a lens being cut with a plane parallel to an optical axis;

FIG. 2 is a diagram showing a process of manufacturing the lens;

FIG. 3 is a schematic diagram of a camera;

FIG. 4 is a diagram showing a manufacturing process according to a first exemplary embodiment;

FIG. 5A is a diagram showing an SEM photograph of a surface of the lens in a process of FIG. 2(D) of the first exemplary embodiment;

FIG. 5B is a diagram showing a result of measurement of reflectivity in the process of FIG. 2(D) of the first exemplary embodiment;

FIG. 6A is a diagram showing an SEM photograph of the surface of the lens in a process of FIG. 2(C) of the first exemplary embodiment;

FIG. 6B is a diagram showing a result of measurement of the reflectivity in the process of FIG. 2(C) of the first exemplary embodiment;

FIG. 7 is a diagram showing a manufacturing process according to a second exemplary embodiment;

FIG. 8A is a diagram showing an SEM photograph of a section of a lens in the second exemplary embodiment;

FIG. 8B is a diagram showing a result of measurement of reflectivity in the second exemplary embodiment;

FIG. 9 is a diagram showing a manufacturing process according to a third exemplary embodiment; and

FIG. 10 is a diagram showing an SEM photograph of a surface of a lens in the third exemplary embodiment.

### DETAILED DESCRIPTION

Hereinafter, exemplary embodiments are described in detail with reference to the drawings.

### 1. Outline of Lens

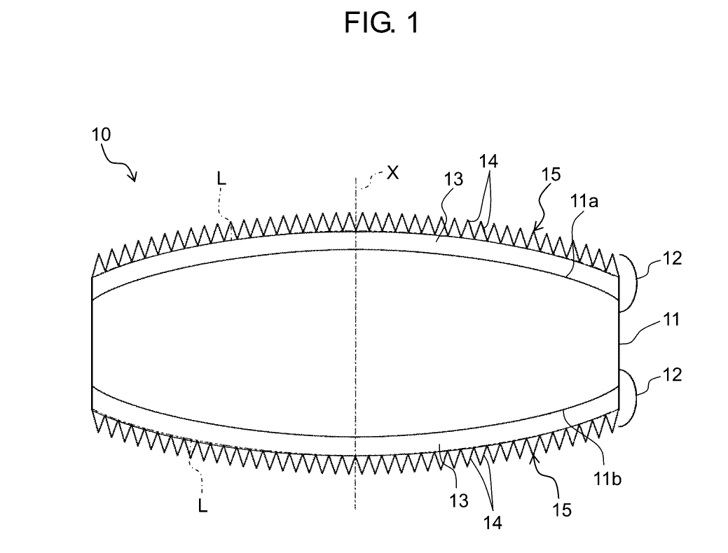

FIG. 1 shows a cross sectional view obtained by cutting lens 10 with a plane parallel to an optical axis X.

Lens 10 has lens body 11 and antireflection layers 12 provided on both surfaces of lens body 11. Lens 10 is a biconvex-shaped lens. Both surfaces of lens 10 are optical functional surfaces (also called optical effective surfaces). Lens 10 is one example of the optical member on which a minute uneven structure is formed.

According to this disclosed technology, for example, a catalyst layer is formed on a surface of the lens body (also called a substrate of the optical member), and bump structures each of which is zinc oxide (ZnO) oriented in a C-axis and is of a bell shape or a pyramid shape are disposed substantially periodically on a surface of this catalyst layer.

Lens body 11 forms a fundamental structure of lens 10. That is, lens body 11 is biconvex shaped. Surfaces 11a, 11b of lens body 11 are formed in shapes that are required in order to realize an optical characteristic needed for lens 10. Surfaces 11a, 11b are smooth curved surfaces, for example. For example, surfaces 11a, 11b may be formed into a spherical shape, an aspheric shape, or a free curved surface. Incidentally, surfaces 11a, 11b may be planes. Lens body 11 may be a plastic molded article manufactured by injection molding. Incidentally, lens body 11 is not limited to the plastic molded article, and may be formed of glass.

Since antireflection layer 12 having surface 11a and antireflection layer 12 having surface 11b are the same in fundamental configuration, in the following, antireflection layer 12 having surface 11a is described.

Antireflection layer 12 has antireflection structure (SWS: Sub Wavelength Structure) 15 that reduces reflection of light. SWS 15 is one example of the minute uneven structure. SWS 15 has catalyst layer 13 and multiple projections 14 disposed on catalyst layer 13.

Projections 14 comprised of ZnO are formed over an entire surface of catalyst layer 13. Therefore, projections 14 comprised of ZnO are disposed on surface 11a of lens body 11 without gaps therebetween and each one of the bumps adheres closely to surface 11a of lens body 11.

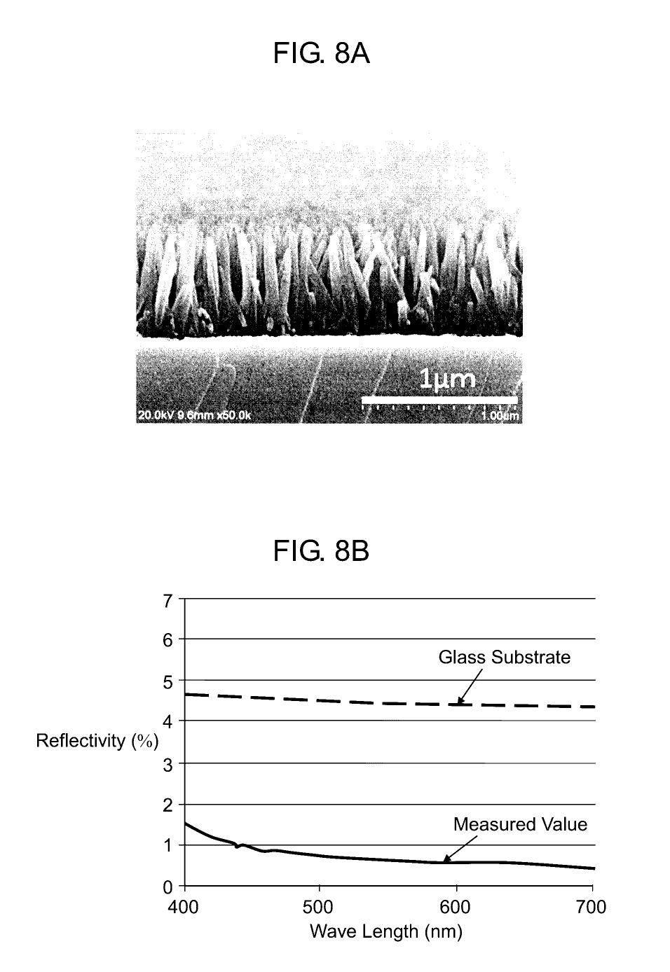

Here, “projections 14 are disposed without gaps therebetween” means that multiple adjacent projections 14 are disposed with their bottom parts (i.e., the lowest portions of projections 14) mutually linked in a state where there is no flat parts between projections 14 (for example, refer to FIG. 8A). Incidentally, as will be described later, the vertexes of adjacent projections 14 have a predetermined pitch therebetween.

According to the technology disclosed here, it is possible to avoid projections 14 from peeling off from lens body 11 by providing catalyst layer 13 between lens body 11 and projections 14.

Projections 14 are disposed at the predetermined pitch (period) or less. The predetermined pitch is set to be a smaller gap than a wavelength (hereinafter referred to as a “target wavelength”) of light that is a target whose reflection is to be reduced by reflection antireflection layer 12 (hereinafter such light will be referred to as “target light”). That is, multiple projections 14 reduce at least reflection of light having a wavelength more than or equal to the predetermined pitch. Projections 14 have a tapered shape, such as a bell shape and a cone, for example. Projections 14 may extend in a direction that inclines to the optical axis X, may extend to curve to the optical axis X, or may extend to bend. That is, SWS 15 starts to change its refractive index gradually from an air layer (refractive index n0=1) toward the lens material (refractive index n1>1), and creates the antireflection structure that does not cause surface reflection.

### 2. Detailed Configuration of Projection

In antireflection layer 12, the minute uneven structure is formed by multiple projections 14 being disposed. A virtual plane that is formed by connecting bottom parts (the lowest portions) of multiple concavities, i.e., the surface of catalyst layer 13, is referred to as a base plane L. The base plane L is formed substantially parallel to surfaces 11a, 11b of lens body 11.

Here, a pitch of projections 14 is a distance between peaks of adjacent projections 14 in a direction parallel to a plane that intersects perpendicularly with the optical axis X. Moreover, the height of the projections in the optical axis direction of projections 14 is a distance in the optical axis direction from the peak of projections 14 to the base plane L.

When lens 10 is used in the imaging optics, the target light is visible light. In that case, since the target wavelengths ranges from 400 nm to 700 nm, it is preferable that the pitch of projections 14 be less than or equal to 400 nm. With such a pitch, reflectivity for the target light (for example, visible light) can be made to be less than or equal to 1% at a center wavelength of 550 nm.

Moreover, it is preferable that the reflectivity for the target light (for example, visible lights) of SWS 15 be less than or equal to 1% at the center wavelength of 550 nm. From a viewpoint of realizing a high antireflection effect, it is preferable that projections 14 have a height that is more than or equal to 0.4 times of the target wavelength. In the case where the target light is visible light, it is preferable that projections 14 have a height that is more than or equal to 280 nm. More preferably, projections 14 have a height that is more than or equal to 500 nm.

Furthermore, in order not to generate diffracted light, it is preferable that the pitch of projections 14 be set less than or equal to a solution obtained by dividing the target wavelength by a refractive index of lens 10. In the case where the target wavelength is visible light and the refractive index of lens 10 is 1.5, it is preferable that the pitch of projections 14 be less than or equal to 266 nm.

Incidentally, in the optical functional surface of lens 10, it is preferable to keep its reflectivity lower and to make its transmissivity higher. That is, preferably, by setting projections 14 to have a pitch that is less than or equal to 266 nm and a height that is more than or equal to 280 nm, the reflectivity in the whole range of visible lights can be set to less than or equal to 1%, and an excellent effect of reflection suppression can be obtained. Incidentally, when ease of manufacturing is considered, it is preferable that projections 14 have a pitch of 50 nm to 266 nm, and projections 14 have a height of 280 nm to 2000 nm. For example, by setting projections 14 to have a pitch of 230 nm and a height of 350 nm, the reflectivity in the entire region of visible light can be made to be less than or equal to 1% and the excellent effect of reflection suppression can be obtained.

Antireflection layer 12 includes projections 14 comprised of ZnO that is a transparent material and catalyst layers 13 that are made thin in thickness so that penetration of light may not be prevented and each contain at least one element selected from among Pd, Pt, Au, Ag, Ru, and Rh, in order to reduce surface reflection of the optical member.

Thus, catalyst layer 13 and projections 14 comprised of ZnO can be easily manufactured on a surface of the optical member, such as lens 10, by a manufacturing method shown below.

### 3. Manufacturing Method

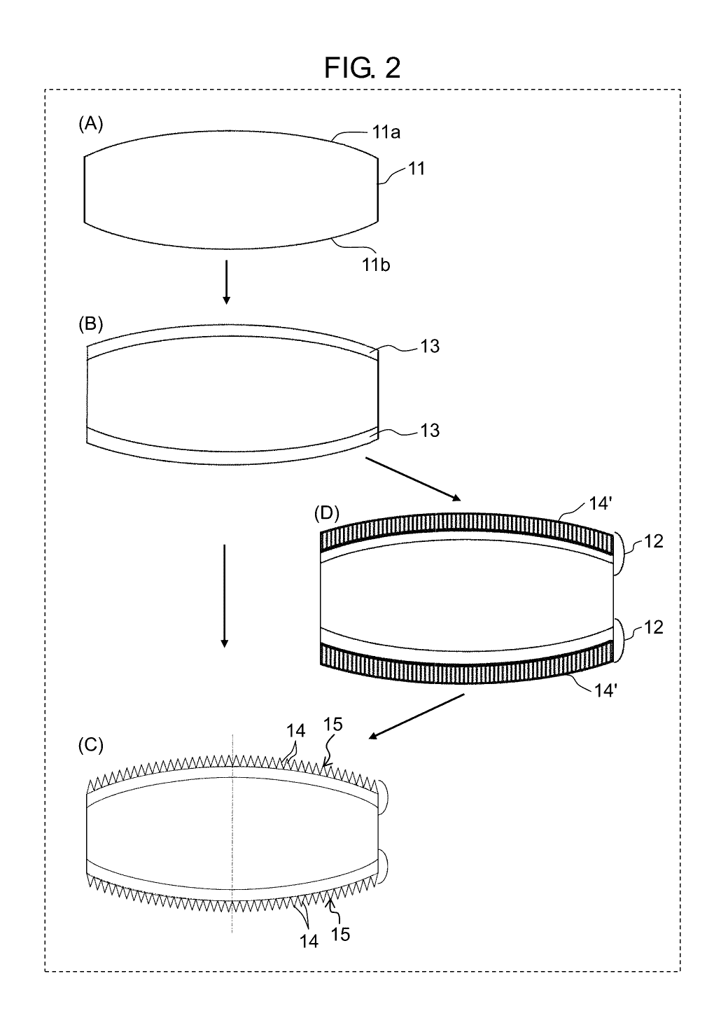

Below, the method for manufacturing lens 10 is described. FIG. 2 is a diagram showing a process of manufacturing lens 10.

First, as shown in FIG. 2(A), lens body 11 is prepared. Lens body 11 is formed by, for example, the injection molding, and has convex surfaces 11a, 11b.

Next, as shown in FIG. 2(B), by immersing lens body 11 in a solution containing at least one element selected from among Pd, Pt, Au, Ag, Ru, and Rh, catalyst layers 13 are formed on surfaces 11a, 11b of lens body 11.

The solutions used in this process are, for example, Techno clear SN solution, Techno clear AG solution, Techno clear PD solution, and the like manufactured by Okuno Chemical Industries Co., Ltd.

Moreover, a time required to form catalyst layers 13 on surfaces 11a, 11b of lens body 11 is 0.5 to five minutes and it is preferable to maintain a temperature of the solution at a room temperature (for example, 25° C.) during the process.

At this moment, it is preferable that the thickness of catalyst layer 13 be less than or equal to several nanometers in order not to impair the transmissivity. Preferably, the thickness of catalyst layer 13 is about 0.5 nm to 30 nm.

Subsequently, as shown in FIG. 2(C), projections 14 that are comprised of ZnO and are of a bell shape or a pyramid shape are formed by immersing lens body 11 on which catalyst layer 13 is formed in a ZnO electroless plating solution. Projections 14 constitute SWS 15 as they are, and lens 10 having antireflection layers 12 formed on its surface is completed.

The ZnO electroless plating solution used in the technology disclosed here is, for example, a solution for Techno clear-B process manufactured by Okuno Chemical Industries Co., Ltd. For example, Techno clear ZN-M-V2, Techno clear ZN-R-V2, and a mixture of them can be used.

Depending on plating conditions and formation conditions of catalyst layer 13 of FIG. 2(B), there is a case where projections 14′ of a hexagonal pillar shape in which a ZnO single crystal is oriented in the C-axis are formed (FIG. 2(D)). In that case, projections 14 are processed to be of a bell shape or a pyramid shape by dissolving or chipping tip portions of the hexagonal pillars through wet etching or dry etching. Thus, projections 14 are formed and SWS 15 is formed over the surface of the lens. In this way, antireflection layers 12 are formed on both surfaces 11a, 11b of lens body 11. As a result, similarly lens 10 is completed.

The wet etching may be done using a phosphoric acid solution of 0.2M, for example. Moreover, the dry etching may be done using, for example, a method for irradiation with RF plasma including Ar ions, and a method for irradiation with ICP plasma that uses an F-containing or Cl-containing gas.

Here, a width, a height, and a pitch of projections 14 can be controlled by the formation conditions of catalyst layer 13, a concentration of the ZnO electroless plating solution, and the plating conditions.

For example, if the time of ZnO electroless plating conditions is lengthened, SWS 15 that has almost an identical pitch but is different in height of the projections, that is, SWS 15 with a different aspect ratio can be formed.

Moreover, if the concentration of the ZnO electroless plating solution is changed, the density of projections 14 changes and the pitch can be changed as a result. About, formation of a ZnO crystal with a size of 100 nm to several micrometers is possible.

Moreover, regarding SWS 15, since an addition process for the catalyst layer and the ZnO electroless plating process can be performed just by immersing the optical member in a predetermined solution, SWS 15 can be formed very easily on an optical member of a whatever shape (for example, an inner surface of a lens barrel, and the like). Moreover, since the temperature of the ZnO electroless plating solution is usually 100° C. or less, SWS 15 can be formed also on materials without heat resistance, such as plastics. Therefore, SWS 15 can be formed on almost all optical members.

### 4. Camera

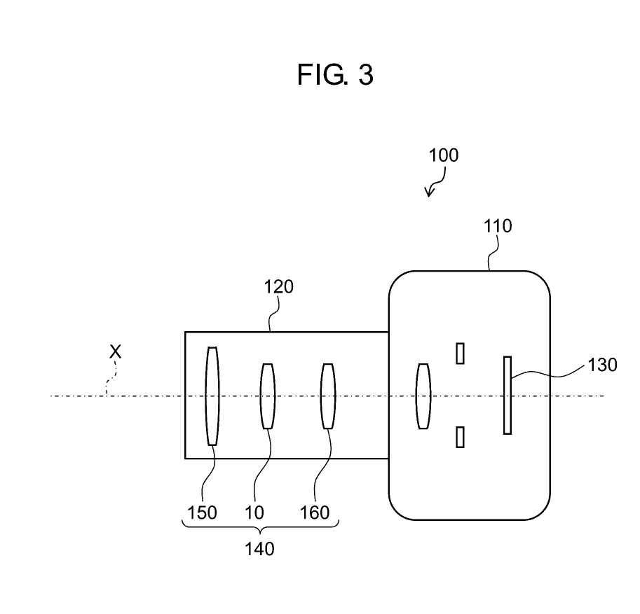

Next, camera 100 provided with lens 10 is described. FIG. 3 shows an outline cross sectional view of camera 100.

Camera 100 has camera body 110 and interchangeable lens 120 attached to camera body 110. Camera 100 is one example of the image pickup device.

Camera body 110 has image sensor 130.

Interchangeable lens 120 is configured to be detachable to camera body 110. Interchangeable lens 120 is, for example, a telephoto zoom lens. Interchangeable lens 120 has imaging optics 140 for focusing a light beam on image sensor 130 of camera body 110. Imaging optics 140 has above-mentioned lens 10 and refracted type lenses 150, 160. Since lens 10 functions as a lens element and has SWS 15, reflection of a lens surface decreases, and therefore flare and ghosts that are caused by reflection of the lens surface can be reduced.

Furthermore, since SWS 15 can be formed also in the inner surface of the lens barrel of interchangeable lens 120, reduction of the flare and ghosts is realized further.

### 5. Effect

Lens 10 has SWS 15 provided on its surface and SWS 15 has catalyst layer 13 and multiple projections 14 disposed on catalyst layer 13. Projections 14 comprised of ZnO are formed over the entire surface of catalyst layer 13. Therefore, projections 14 comprised of ZnO are disposed on surface 11a of lens body 11 without any gaps therebetween and each one of the bumps adheres closely to surface 11a of lens body 11 through catalyst layer 13.

Projections 14 are disposed at the predetermined pitch (period) or less. The predetermined pitch is set smaller than the wavelength (hereinafter referred to as the “target wavelength”) of the light that is a target whose reflection is to be reduced by reflection antireflection layer 12 (hereinafter such light will be referred to as the “target light”). That is, multiple projections 14 reduce at least reflection of light having a wavelength more than or equal to the predetermined pitch. Projections 14 have a tapered shape, such as a bell shape and a cone, for example.

Such projections 14 can be formed just by immersing lens body 11 in the ZnO electroless plating solution in each process of performing ZnO electroless plating on lens body 11. Therefore, even if an optical member of whatever shape (for example, the inner surface of the lens barrel, and the like) is considered, SWS 15 can be formed very easily. Moreover, since a temperature of the plating solution of ZnO is usually 100° C. or less, SWS 15 can be formed also on materials without heat resistance, such as plastics. Therefore, SWS 15 can be formed on almost all the optical members. As a result, lens 10 provided with SWS 15 can be manufactured easily.

Incidentally, dimensions, such as a width, a pitch, and the height of projections 14, can be controlled by the formation conditions of catalyst layer 13, the concentration of the ZnO electroless plating solution, and the plating conditions.

For example, if a time of the ZnO electroless plating conditions is lengthened, SWS 15 that has almost the same pitch but is different in height of the projections, that is, SWS 15 that is different in aspect ratio can be formed.

Moreover, if the concentration of the ZnO electroless plating solution is changed, a density of projections 14 changes and the pitch can be changed as a result. Formation of a ZnO crystal with a size of 100 nm to several micrometers is possible.

Since projections 14 comprised of ZnO are transparent, the light entered into SWS 15 intrudes into the inside of lens body 11 through multiple projections 14 without being reflected by multiple projections 14. Then, the light can penetrate with high transmissivity.

Moreover, it is preferable that the reflectivity of SWS 15 to visible lights be less than or equal to 1% at the center wavelength of 550 nm.

Moreover, projections 14 has a height more than or equal to 500 nm, for example.

According to the above-mentioned configuration, when multiple projections 14 are used for reflection reduction of light, a high reflection reduction effect can be exhibited to at least visible light.

### Other Exemplary Embodiments

As described above, the above-mentioned exemplary embodiments have been described as illustrations of the technology disclosed in this application. However, this disclosed technology is not limited thereto, but can be applied also to exemplary embodiments in which alteration, substitution, addition, and abbreviation are suitably performed. Moreover, it is also possible to combine components described in the above-mentioned exemplary embodiments to realize a new exemplary embodiment. Moreover, among the components described in the accompanying drawing and in the detailed description, not only essential components but also nonessential components to illustrate the above-mentioned technology may be included. Therefore, it should not be recognized that these nonessential components are essential just because these nonessential components are described in the accompanying drawing and in the detailed description.

The above-mentioned exemplary embodiments may be altered to have the following configuration.

For example, the optical member on which the minute uneven structure is formed is not limited to the lens. The technology may be applied to optical members other than the lens. It is possible to form the SWS on an optical member that has an optical functional surface such as the inner surface of the lens barrel and a display surface; for example, optical members having any shapes of a curved surface, an inner surface of a barrel, a large area, and the like and on which it is difficult to form a conventional antireflection film. Furthermore, since the minute uneven structure can be formed at a temperature of 100° C. or less, the SWS can be formed also on a plastic material that does not have heat resistance. Therefore, the technology exhibits the effect especially on optical members on which the antireflection processing, such as of the conventional antireflection film, cannot be performed.

Conventionally, reflected light from the surface of the optical member existing on the periphery of the lens may become stray light to a light receiver. Therefore, emboss processing and the like have been processed on surfaces of the optical members on the periphery of the lens. However, the emboss processing does not eliminate stray light, but reduces the incident amount of the stray light into the light receiver by changing directions of reflected light through scattering of the reflected light, and consequently reduces image quality deterioration of flare and the like by the stray light. Therefore, the flare and the like cannot be suppressed completely only by the emboss processing and adjustment of incident light direction is also needed. Since the stray light to the lens can be considerably reduced by forming the minute uneven structure on the optical member on the periphery of the lens, it becomes unnecessary to provide the antireflection film of the optical member, and the like.

### EXAMPLES

Hereinafter, a description will be given of examples of a lens on which the minute uneven structure is formed, and a method for manufacturing the lens.

### Example 1

In Example 1, for formation of the catalyst layer and ZnO electroless plating, various solutions for Techno clear-B process manufactured and sold on the market by Okuno Chemical Industries Co., Ltd. were used to form the minute uneven structure on a plate glass substrate.

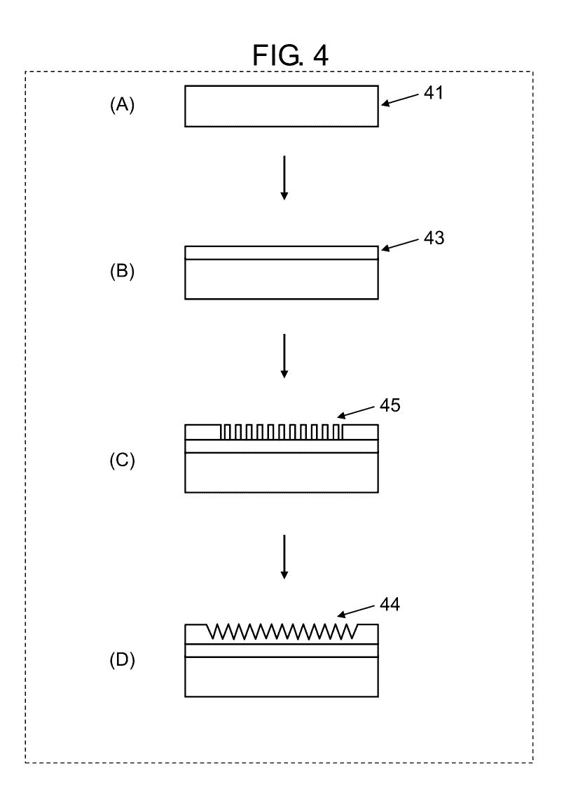

FIG. 4 shows a process of manufacturing the minute uneven structure.

First, as shown in FIG. 4(A), glass substrate 41 was cleaned, was immersed in 50° C. Techno clear CL solution for five minutes, was taken out from the solution as it was, and was washed with water. Next, this glass substrate 41 was immersed in 25° C. Techno clear SN solution for two minutes, and was washed with water. Next, this glass substrate 41 was immersed in 25° C. Techno clear AG solution for one minute, and was washed with water. Then, by immersing this glass substrate 41 in 25° C. Techno clear PD solution for one minute, as shown in FIG. 4(B), catalyst layer 43 comprised of Pd and Ag is formed on the surface of glass substrate 41 with a high density and with sufficient adhesion.

Subsequently, glass substrate 41 on whose surface catalyst layer 43 was formed was further washed with water, and was immersed in 80° C. ZnO electroless plating solution (a mixed solution of Techno clear ZN-M-V2 and Techno clear ZN-R-V2 with a mixture ratio of Techno clear ZN-M-V2:Techno clear ZN-R-V2=50 mL/L:20 mL/L by conversion of concentration ratio) for 40 minutes. Thereby, minute uneven structure 45 in which as shown in FIG. 4(C), the bumps of the hexagonal pillar single crystals of ZnO were closely aligned on the surface of catalyst layer 43 was obtained.

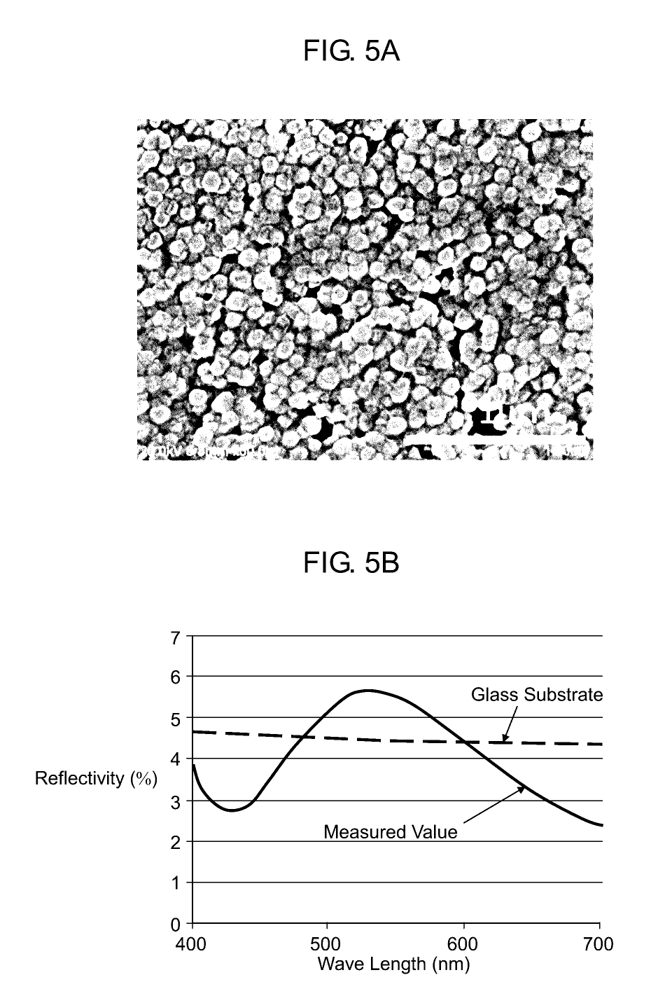

FIG. 5A shows a surface SEM photograph in this state and FIG. 5B shows a result that reflectivity in this state is measured. According to FIG. 5A, the hexagonal pillar single crystals of ZnO are formed closely so that there may be few flat parts of glass substrate 41, and create a structure where the projection structures of the hexagonal pillar are disposed. Since refractive index change from the surface on an air layer side occurs abruptly, such a structure does not work as antireflection and shows the same behavior of reflectivity as when a thin film of ZnO is formed. That is, as shown in FIG. 5B, increase/decrease in reflectivity shows a sine wave shape for every λ/4. Since such a structure does not work as the antireflection structure as it is, further the structure in this state was immersed in the phosphoric acid solution of 0.2M and the hexagonal pillar single crystals of ZnO were solved by wet etching until the tip portions of the hexagonal pillar single crystals of ZnO became in a tapered shape. Thus, the optical member having projections 44 comprised of bell-shaped ZnO shown in FIG. 4(D) was obtained.

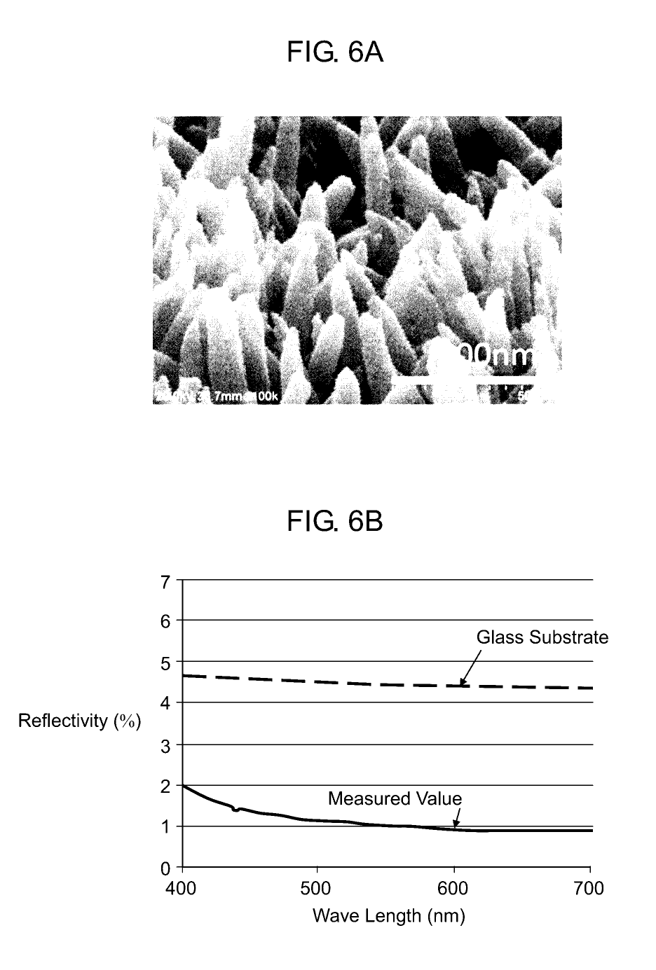

FIG. 6A shows a surface SEM photograph in this state and FIG. 6B shows a result that reflectivity in this state is measured. According to FIG. 6A, single crystals of ZnO of a bell shape are formed closely so that there may be few flat parts of glass substrate 41, and create a structure where projection structures of the bell shape are disposed.

As can be understood from FIG. 6B, when the tips of the uneven structure become thin, a refractive index change of the plane on which the unevenness is formed becomes gentle to effect the antireflection structure, the reflectivity lowers in the region of visible light, and the reflectivity becomes less than or equal to 1% at the center wavelength of 550 nm.

### Example 2

In Example 2, for formation of the catalyst layer and ZnO electroless plating, various solutions for Techno clear-B process manufactured and sold on the market by Okuno Chemical Industries Co., Ltd. were used to form the minute uneven structure on the plate glass substrate.

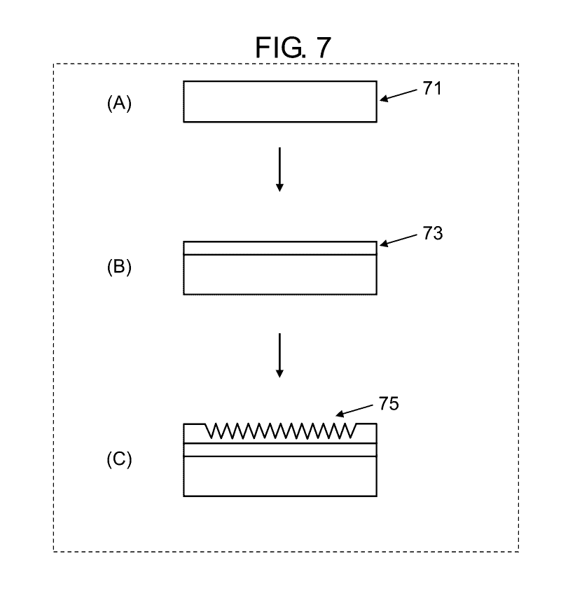

FIG. 7 shows a process of manufacturing the minute uneven structure.

First, as shown in FIG. 7(A), glass substrate 71 was cleaned, was immersed in 50° C. Techno clear CL solution for five minutes, was taken out from the solution as it was, and was washed with water. Next, this glass substrate 71 was immersed in 25° C. Techno clear SN solution for two minutes, and subsequently was washed with water. Next, this glass substrate 71 was immersed in 25° C. Techno clear AG solution for one minute, and subsequently was washed with water. Then by immersing this glass substrate 71 in 25° C. Techno clear PD solution for one minute, as shown in FIG. 7(B), catalyst layer 73 comprised of Pd and Ag was formed with a high density and with sufficient adhesion on a surface of glass substrate 71.

Subsequently, glass substrate 71 on whose surface catalyst layer 73 was formed was further washed with water, and was immersed in 70° C. ZnO electroless plating solution (a mixed solution of Techno clear ZN-M-V2 and Techno clear ZN-R-V2 with a mixture ratio of Techno clear ZN-M-V2:Techno clear ZN-R-V2=50 mL/L:20 mL/L by conversion of concentration ratio) for 40 minutes. Thereby, as shown in FIG. 7(C), the optical member having minute uneven structure 75 such that on the surface of catalyst layer 73, bumps of hexagonal pyramidal single crystals of ZnO were disposed closely was obtained.

FIG. 8A shows a surface SEM photograph in this state and FIG. 8B shows a result that reflectivity in this state is measured. According to FIG. 8A, the single crystals of a hexagonal pyramid shape of ZnO are formed closely so that there may be few flat parts of glass substrate 71, and create a structure where projection structures of the hexagonal pyramid shape are disposed.

As can be understood from FIG. 8B, when the tips of the uneven structure become thin, a refractive index change of the surface becomes gentle to effect the antireflection structure, the reflectivity lowers in the region of visible light, and the reflectivity becomes less than or equal to 1% at the center wavelength of 550 nm.

### Example 3

In example 3, for formation of the catalyst layer and ZnO electroless plating, various solutions for Techno clear-B process manufactured and sold on the market by Okuno Chemical Industries Co., Ltd. were used to form the minute uneven structure on the lens cap made of polycarbonate.

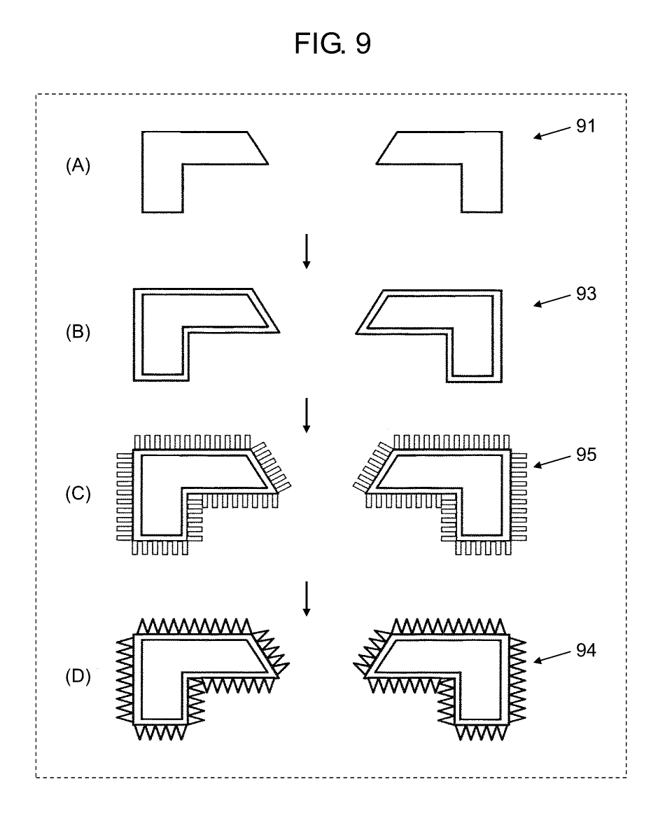

FIG. 9 shows a process of manufacturing the minute uneven structure.

First, lens cap 91 made of polycarbonate obtained by the injection molding as shown in FIG. 9(A) was cleaned. Next, this lens cap 91 was immersed in 50° C. Techno clear CL solution for five minutes, subsequently was taken out from the solution as it was, and was washed with water. Next, this lens cap 91 was immersed in 25° C. Techno clear SN solution for two minutes, and was washed with water. Next, this lens cap 91 was immersed in 25° C. Techno clear AG solution for one minute, and was washed with water. Then by immersing this lens cap 91 in 25° C. Techno clear PD solution for one minute, as shown in FIG. 9(B), catalyst layer 93 comprised of Pd and Ag was formed on a surface of lens cap 91 with a high density and with sufficient adhesion.

Subsequently, lens cap 91 having catalyst layer 93 formed on its surface was formed was further washed with water, and was immersed in the 80° C. ZnO electroless plating solution (a mixed solution of Techno clear ZN-M-V2 and Techno clear ZN-R-V2 with a mixture ratio of Techno clear ZN-M-V2:Techno clear ZN-R-V2=50 mL/L:20 mL/L by conversion of concentration ratio) for 40 minutes. Thereby, as shown in FIG. 9(C), minute uneven structure 95 in which the bumps of the hexagonal pillar single crystals of ZnO were aligned closely on a surface of catalyst layer 93 was obtained. Since such a structure does not work as the antireflection structure as it is, further the structure in this state was immersed in the phosphoric acid solution of 0.2M to solve the hexagonal pillar single crystal of ZnO by wet etching until the tip portions of the bumps formed by the hexagonal pillar single crystals of ZnO became in a tapered shape. Thus, the optical member that has projections 94 comprised of bell-shaped ZnO as shown in FIG. 9(D) was obtained.

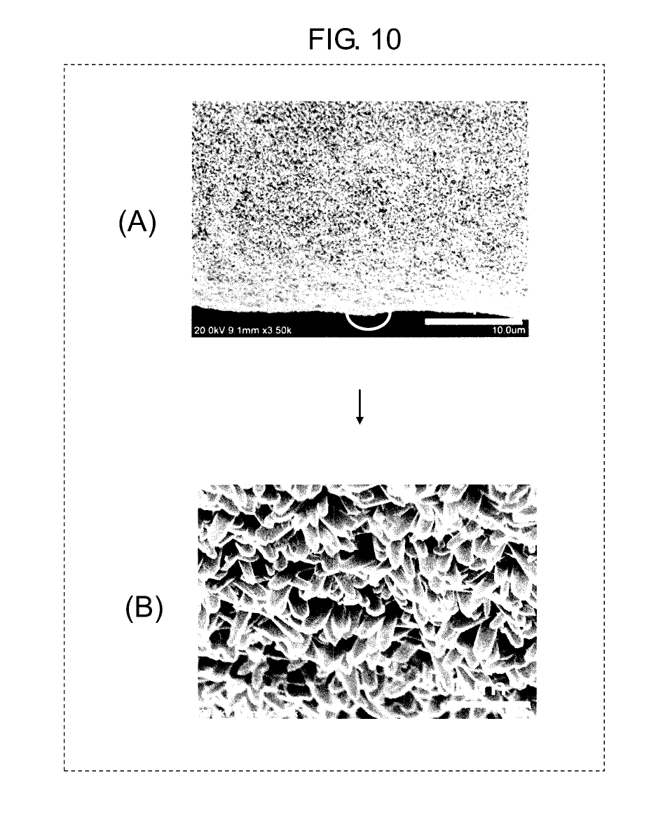

FIG. 10 shows surface SEM photographs in this state. FIG. 10(A) is an SEM photograph with a scale of 10 μm and FIG. 10(B) is an SEM photograph with a scale of 1 μm. According to FIG. 10, the bell-shaped single crystals of ZnO are formed closely so that there may be few flat parts on the entire surface of lens cap 91, and create a structure where the bell-shaped projection structures are disposed.

It is understood that it is possible to form the SWS easily on a member on whose surface, such as of the lens cap, it is extremely difficult to form the minute uneven structure, and what is more, even on polycarbonate having low heat resistance as compared to glass.

As described above, the technology disclosed here is useful in order to form the minute uneven structure on the surface of the optical member.

What is claimed is:

1. An optical member including an optical functional surface made of a plastic material is disposed on the periphery of a lens of an image pickup device, the optical member comprising:
a catalyst layer formed on the optical functional surface of the optical member; and
zinc oxide having a minute uneven structure where bump structures each of which is oriented in a C-axis and is of a bell shape or a pyramid shape are disposed substantially periodically on a surface of the catalyst layer.

2. The optical member according to claim 1,
wherein the catalyst layer contains a catalyst material mainly including at least one element selected from among palladium, platinum, gold, silver, ruthenium, and rhodium.

3. The optical member according to claim 1,
wherein reflectivity of the minute uneven structure with respect to a wavelength of 550 nm is less than or equal to 1%.

4. The optical member according to claim 1,
wherein each of the bump structures has a height that is more than or equal to 500 nm.

5. The optical member according to claim 1,
wherein the bump structures of the minute uneven structure are disposed on a surface of the optical member with no gaps therebetween.

6. A method for manufacturing an optical member, comprising:
a first step of putting an optical functional surface of an optical member into an aqueous solution containing at least one element selected from among palladium, platinum, gold, silver, ruthenium, and rhodium, and forming, on the optical functional surface, a catalyst layer mainly including the at least one element;
a second step of generating zinc oxide of hexagonal pillar bump structures oriented in a C-axis on a surface of the catalyst layer by putting the optical functional surface of the optical member having the catalyst layer formed on a surface thereof into an aqueous solution containing zinc oxide; and
a third step of forming the zinc oxide of the hexagonal pillar bump structures into bump structures of a bell shape or a pyramid shape by dry etching or wet etching.

7. A method for manufacturing an optical member comprising:
a first step of putting an optical functional surface of an optical member into an aqueous solution containing at least one element selected from among palladium, platinum, gold, silver, ruthenium, and rhodium, and forming, on the optical functional surface, a catalyst layer mainly including the at least one element, and
a second step of generating zinc oxide of bump structures each of which is oriented in a C-axis and is of a hexagonal pyramid shape or a bell shape on a surface of the catalyst layer, by putting the optical functional surface of the optical member having the catalyst layer formed on a surface thereof into an aqueous solution containing zinc oxide.

8. An image pickup device comprising:
an imager having an image sensor; and
an optical member including a lens attached to the imager and an optical functional surface made of a plastic material disposed on the periphery of the lens,
wherein the optical member has:
a catalyst layer formed on the optical functional surface of the optical member; and
zinc oxide having a minute uneven structure where bump structures each of which is oriented in a C-axis and is of a bell shape or a pyramid shape are disposed substantially periodically on a surface of the catalyst layer.
